(19) United States
(12) Patent Application Publication
(10) Pub. No.: US 2003/0164816 A1
(43) Pub. Date: Sep. 4, 2003

(54) Method and device for remote control of reset and power supply to computers by way of console-video-mouse extension (KVM extender)

(76) Inventors: Christian Paetz, Zwickau (DE); Sven Anderson, Burgstaedt (DE)

Correspondence Address: COLLARD & ROE, P.C., 1077 Northern Boulevard, Roslyn, NY, 11576-1696, US

(21) Appl. No.: 10/339,442

(22) Filed: Jan. 9, 2003

(30) Foreign Application Priority Data
Jan. 9, 2002 (DE) 102 00 460.9

(51) Int. Cl. G09G 5/00

(52) U.S. Cl. 345/156

(57) ABSTRACT

A method and a device with which switching of the supply voltage and a hardware reset can be carried out on computers from a distance, via a console-video-mouse extension. It is carried out without additional cable connections, by a remote control. The necessary control data are transmitted within the control for the keyboard and the mouse.

### BACKGROUND

The remote control of a computer typically has the ability to send video, keyboard, and mouse signals to a remote location, via control lines. The signals are transmitted to the interfaces of a computer for video or for control of the mouse and keyboard. These signals may be coded in a suitable manner. Coding is a preferable protocol for communications networks (e.g. IP), making it possible to control the computers over greater distances using a communication network. However, this technology, also known as a KVM extender, is limited to remote control keyboard and mouse signals. In order to allow complete remote control of a computer, a KVM extender must be combined with a remote-controllable power supply. This can be achieved with an uninterruptable switchable power supply (USV) or a switchable power extension of the power supply network.

This additional power switching control requires additional cables. Thus, it is difficult to integrate the power supply into the control of the KVM extender, and it is limited to turning on and interrupting the power supply network.

### SUMMARY

The present invention is a method for remote triggering of a system reset or an on/off switch of a computer. The computer is remote controlled via a keyboard-video-mouse extension (KVM extender). The necessary control data for switching the system sent as special codes or code sequences. These codes are sent to a special control unit that is directly connected with the keyboard or mouse interfaces of the remote controlled computer. The codes are then converted into control signals.

The control signals are passed into a housing of the remote controlled computer via a cable extension. The appropriate inputs are switched there on the main board. The special codes or code sequences are freely programmable.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 shows the system capable of resetting or turning a computer on or off having a computer and a control unit and their connections; and

FIG. 2 shows the system microcontroller and battery and their connections.

### DETAILED DESCRIPTION

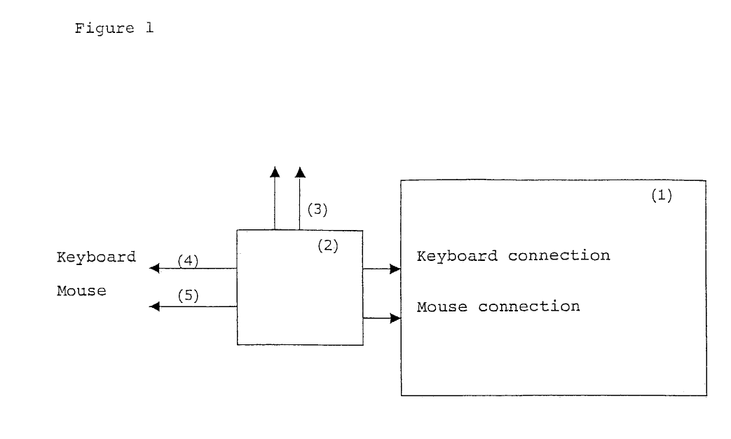

Referring in detail to the drawings, FIG. 1 shows a system having suitable control signals for turning a computer on and off, or for triggering a system reset, so that it may be remote-controlled. The system requires no additional cabling effort or expenditure. A control unit 2 is switched into one or both of the connection lines for a keyboard 4 and a mouse 5, directly at a computer 1 to be remote-controlled. Control unit 2 generates signals for switching the voltage and for triggering a reset available as control outputs 3.

The remote-control lines for keyboard 4 and mouse 5 are no longer switched directly at computer 1, but rather at control unit 2. Defined control codes for keyboard 4 or mouse 5 are sufficiently complex so that they are not generated randomly within the normal operating functions of keyboard 4 or mouse 5. The control codes also lie outside of the defined scope of codes for keyboard 4 or mouse 5 and result in switching of control outputs 3.

The codes necessary for this switching are generated either by means of a special circuit at the other end of the KVM extender, or by means of a combination of different keys or key sequences of an ordinary PC keyboard

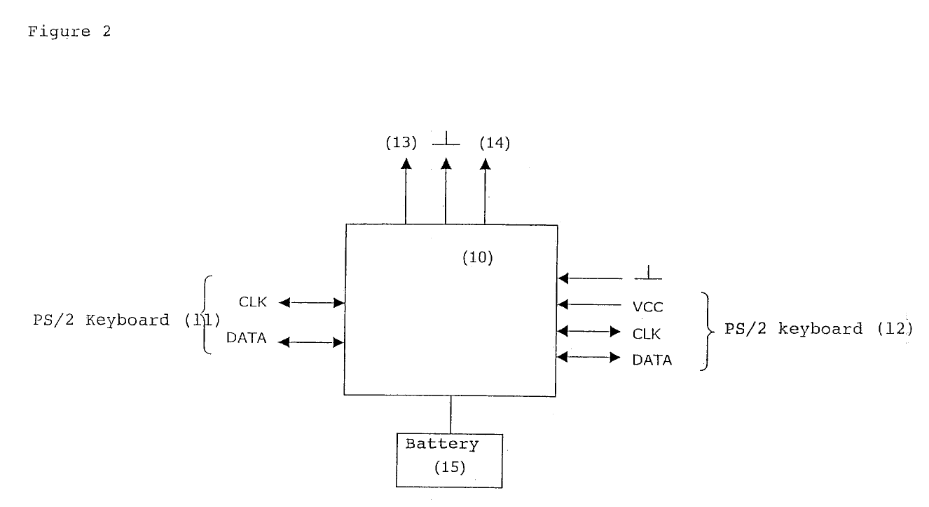

As shown in FIG. 2, an exemplary implementation of the invention is carried out with a microcontroller Atmel AT90S8515 10 . Two PS/2 connections, including power supply 11, 12 are emulated at its control ports. In this connection, power supply 11, 12 of the PS/2 connection of computer (from 12) is used as the power supply for the circuit. When the computer is turned off, the power supply of the microcontroller is provided by means of a battery 15.

Control ports 13 and 14 are used to control the power switching and the system reset. The keyboard extension cable of a KVM extender is connected with connection 11, while connection 12 is connected directly with the keyboard-PS/2 input of the computer to be remote-controlled. The control program of the microcontroller receives keyboard codes at connection 11 and passes them on directly to connection 12. The acknowledgement signals coming from connection 12 are, in turn, passed on to connection 11, so that the entire switching process for the keyboard circuit is transparent.

The control sequences that have previously been defined in code and time intervals are received by microcontroller 10 and trigger the switch in control signals 13 and 14. Appropriate memory resources are available in the microcontroller itself, allowing storage of the (keyboard) control codes to be used for switching control signals 13 and 14. These are passed on to a free bracket at the computer by way of a suitable jack link connection and are connected with the control signals of the network part and the system reset on the main board of the computer to be remote-controlled.

Accordingly, while at least one embodiment of the present invention has been shown and described, it is to be understood that many changes -and modifications may be made thereunto without departing from the spirit and scope of the invention as defined in the appended claims.

What is claimed is:

1. A method for remote triggering of a system reset or for on/off switching of a computer remote-controlled by means of a keyboard-video-mouse extension (KVM extender) comprising the steps of:
sending necessary control data for reset or switching as special codes or code sequences within the control for a keyboard or mouse;
receiving said control data by a special control unit directly connected with said keyboard or said mouse of the remote controlled computer; and
converting said special codes or code sequences into control signals.

2. The method for remote triggering of a system of claim 1 further comprising the step of passing said control signals for resetting or switching into a housing of the remote controlled computer via a cable extension, and switching appropriate inputs there on a main board.

3. The method for remote triggering of claim 1, wherein said special codes or code sequences used for turning the computer on/off or for system reset are freely programmable.
